(19) United States
(12) Patent Application Publication
(10) Pub. No.: US 2012/0318238 A1
(43) Pub. Date: Dec. 20, 2012

(54) IMPROVED PUMP UNIT FOR AN INJECTION APPARATUS OF AN INTERNAL COMBUSTION ENGINE

(75) Inventors: Andrea Emilio Catania, Torino (IT); Alessandro Ferrari, Torino (IT)

(73) Assignee: POLITECNICO DI TORINO, Torino (IT)

(21) Appl. No.: 13/497,319

(22) PCT Filed: Sep. 21, 2010
(86) PCT No.: PCT/IB2010/002359

§ 371 Date: Jul. 31, 2012

(30) Foreign Application Priority Data
Sep. 21, 2009 (IT) TO2009A000715

(51) Int. Cl. F02M 69/16; F04B 49/08

(52) U.S. Cl. 123/452; 417/279

(57) ABSTRACT

A pump unit for an injection apparatus of the Common Rail type comprising a pump body housing at least one pumping element adapted to be rotatably fed to send pressurized fuel towards a feeding storage volume of the injectors, belonging to the pump itself.

### TECHNICAL FIELD

The present invention relates to a new, improved system of the Common Rail (CR) type, with particular reference to a pump of a CR type system.

### BACKGROUND ART

A CR system comprises a high pressure pump, which aspirates diesel fuel from a tank by means of a low pressure pump (LP), a plurality of injectors, which inject the fuel received from the pump into respective combustion chambers, a rail mounted to the motor between the pump and the injectors, a pressure sensor for measuring the pressure in the rail and a valve for adjusting the pressure in the rail by means of the action of a control unit and of the pressure sensor.

In the past, the study for improving the performance of a CR system initially concentrated on how to make injectors. In particular, on how to make micrometric apertures and the respective electromagnetically actuated actuators.

Subsequently, studies aimed at analyzing the problems related to the propagation of undesired pressure waves along the feeding ducts between the rail and the injectors were conducted. The pressure waves are caused by the opening and closing cycles of the injectors and propagate in each feeding duct toward the rail. Perfecting studies were thus conducted to optimize the geometry of the feeding ducts to either avoid or reduce resonance phenomena caused by pressure valve interference.

The role of the rail was only recently investigated, for example in SAE paper n. 2007-01-1258, ‘Common Rail without accumulator: development, theoretical-experimental analysis and performance enhancement at DI-HCCI level of a new generation FIS’ by Catania, Ferrari, Mittica and Spessa. Such a preliminary study ascertained that the rail volume can be reduced to the value of 2.5 cm̂3. Such a value is much lower than the normally used value of 20-40 cm̂3. Such a small volume value of the rail could negatively affect the damping capacity of the rail, and it is therefore advisable to contemplate a duct geometry such as to compensate for such a shortcoming. In particular, the ducts may be made equal in pairs so that two subsequent injectors in firing order (with firing order 1, 3, 4, 2) are connected to respective pipes having a different geometry. In this manner, an at least partially destructive interference can be obtained between the pressure waves triggered by two consequently actuated injectors, so as to avoid excessive perturbations in the storage volume.

Experimental measurements have proved that a CR system with a smaller volume than the volumes normally used has operating features similar to those of a system made and operating on currently marketed vehicles.

In the publication mentioned above, it was indicated for the first time that the performance of the pressure control system in the rail is linked to the synergy between the actions of the pressure adjusting valve and of the storage volume rather than only the action of the latter. In particular, the working cycle of the adjusting valve can be modified by varying the volume of the rail while the required pressure level can still be satisfactorily controlled.

From this it was possible to take into consideration the possibility of considerably decreasing the volume of the rail without negatively affecting, rather even improving, the dynamic features of the system.

Furthermore, a system is described in the aforesaid article in which the pressure inside the storage volume is controlled by a throttling valve on the pump delivery. However, such a method has a relatively low energy efficiency.

It is worth noting that the system used to obtain the results shown in SAE paper n. 2007-01-1258 is a prototype and can be further optimized in view of standard production.

### DISCLOSURE OF INVENTION

It is the object of the present invention to make an injection apparatus of the CR type with high dynamic performance, low costs and which is easy to install on the engine.

Such an object is reached by a CR type system according to claim 1.

### BRIEF DESCRIPTION OF THE DRAWINGS

The invention will now be described with reference to the accompanying drawings which illustrate non-limitative embodiments thereof, in which:

FIG. 1 is a diagrammatic view of a CR system according to the present invention;

FIG. 2 is a diagrammatic view of an alternative embodiment of the present invention.

### BEST MODE FOR CARRYING OUT THE INVENTION

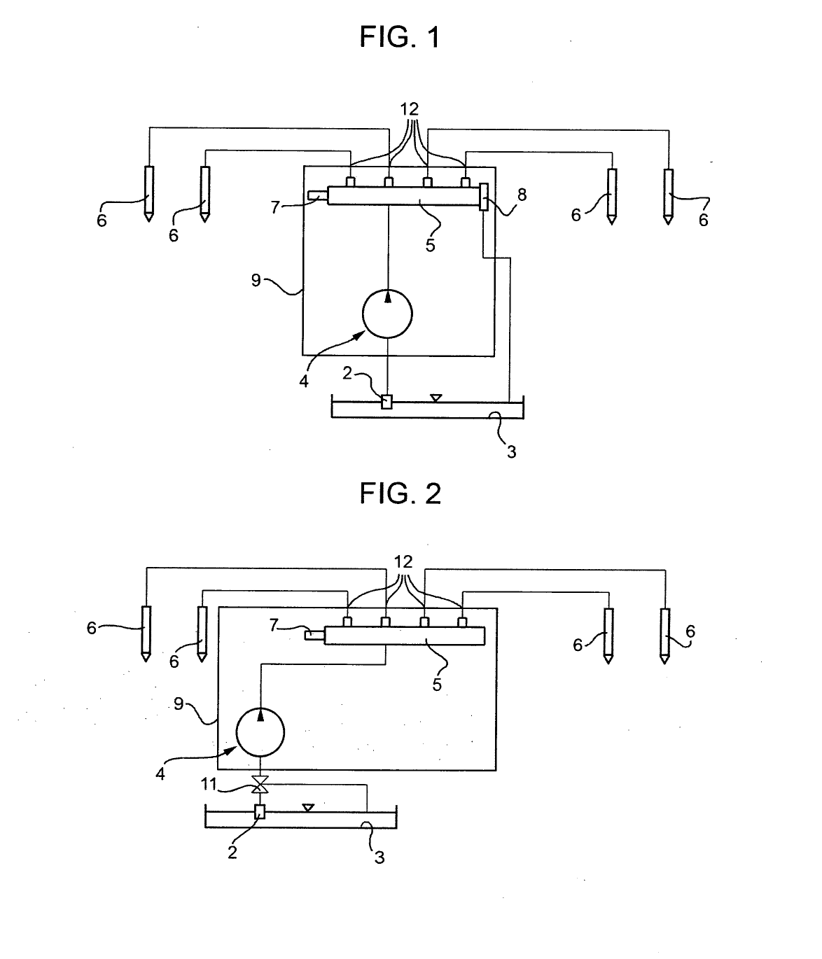

FIG. 1 shows a CR system comprising a preferably electrically actuated LP pump 2 for aspirating diesel fuel from a tank 3, a constant displacement high pressure pump 4 connected to the delivery of the LP pump 2, a storage volume 5 connected to the delivery of the pump 4 and a plurality of injectors 6 connected to the storage volume 5 and controlled by a control unit, not shown in the figure.

According to the invention, the storage volume 5 is obtained in an innovative pump body 9 diagrammatically shown by the rectangular box in FIGS. 1 and 2.

Preferably, the volume is smaller than 5 cm̂3, and even more preferably is approximately 2.5 cm̂3, and this allows to easily modify the previously designed and existing pump body 4.

Furthermore, the innovative pump body 9 is made so as to define four outlet ports 12 connected to the storage volume 5 in parallel to one another. In this manner, the ducts which connect the pump to the injectors are mounted directly onto the pump body 9.

In order to allow to control pressure, the system in FIGS. 1 and 2 comprise a control device connected to the electric control unit.

According to the embodiment shown in FIG. 11, the control device comprises a pressure sensor 7 and a throttling valve 8, preferably a solenoid valve. The pressure sensor 7 and the throttling valve 8 are installed on the pump body 9 and are fluid-dynamically connected to the storage volume 5.

The pressure sensor 7 and the throttling valve 8 are connected to the control unit. In particular, the control unit controls the throttling valve 8 so that the latter conveys to the tank 3 all the delivery flow in excess from the pump 4 on the basis of the pressure value measured by the pressure sensor 7. Such an embodiment has considerable advantages with regards to reducing the reaction time of the engine to acceleration/deceleration controls.

On the basis of the above, the advantages that the CR system described and illustrated in figure 1 allow to obtain are apparent.

A traditional pump body may be easily modified to define both the storage volume 5 and the connections, e.g. threaded, for the pressure sensor 7 and the throttling valve 8, as well as the feeding ducts connected to the injectors.

In this manner, the system in FIG. 1 is more compact than a traditional system, which comprises a dedicated element, i.e. the rail, to define the storage volume 5 external to the pump and mounted on the engine. Furthermore, the implementation costs may be lower because the system has a fewer number of components. In particular, the storage volume external to the pump (rail) can be avoided, as well as the duct connecting the rail to the high pressure pump. Weights are reduced as a consequence.

The saving of weight and volume are complemented by improved dynamic operating stability. All these aspects have a substantial, positive impact in the engine sector.

It is finally apparent that changes and variations can be made to the system described and illustrated in FIG. 1 without departing from the scope of protection defined by the appended claims.

For example, the principle of a small volume storage, and in particular smaller than 5 cm̂3, can be applied to a system having a pressure control device other than that described above. The system in FIG. 2, unlike the system in FIG. 1, has a flow-control valve 11, preferably a solenoid valve, arranged upstream of the intake of pump 4. The flow-control valve 11 is connected to the control unit and adjusts according to the pressure valve measured by the pressure sensor 7. In this manner, the flow diverted towards the tank 3 has a relatively low pressure and energy is saved.

It is observed that traditional CR systems equipped with flow-control valve of the type 11 in FIG. 2 have a higher dynamic response with higher characteristic times than those of the system with throttling valve on rail. However, the use of a storage volume with smaller dimensions, preferably smaller than 5 cm̂3, allows to considerably reduce the hydraulic inertia, and therefore it is particular indicated for improving the performance of the CR system with control valve of the flow at inlet of the pump 4, in particular for reducing the dynamic response time of the system itself.

According to a further aspect of the present invention, it has been experimentally verified that the storage volume may also be smaller than, or equal to 2 cm̂3.

Furthermore, according to a preferred embodiment, the pump 4 comprises a single stage which comprises in turn a pumping element, e.g. a cam, for moving a radial piston.

1. A pump unit for an injection apparatus of the CR type comprising at least one pump body housing at least one pumping element adapted to be rotatably fed to send pressurized fuel to a delivery port, characterized in that said pump body defines a storage volume connected in a fixed, undetachable manner to said delivery port and a pressure sensor and a solenoid valve fluid-dynamically connected to said storage volume for adjusting the delivery pressure by means of said pressure sensor.

2. The pump unit according to claim 1, characterized in that the solenoid valve is connected to discharge into a fuel tank.

3. The pump unit according to claim 1, wherein it comprises a single compression stage comprising the pumping element.

4. The pump unit according to claim 1, wherein said storage volume is smaller than 5 cm̂3.

5. The pump unit according to claim 4, wherein said storage volume is smaller than 2 cm̂3.

6. The pump unit according to claim 1, wherein the solenoid valve is a throttling valve for controlling pressure.

7. The pump unit according to claim 1, wherein the solenoid valve is a flow-control valve.

8. The pump unit according to claim 7, wherein the solenoid valve is arranged upstream of said pumping element.

9. The pumping unit according to claim 1, wherein said pumping unit defines a plurality of outlet ports connected to said storage volume and adapted to be fluid-dynamically connected to a plurality of injectors of said injection apparatus.

10. An injection apparatus for a diesel engine comprising a LP pump, a high pressure pump unit according to claim 1 connected to the delivery of said low pressure pump, a plurality of ducts connected to the delivery of said high pressure pump unit and to a plurality of injectors, said injection system being characterized in that it does not comprise a dedicated component (rail) to be mounted to the engine for defining a storage volume.
